(19) United States
(12) Patent Application Publication
(10) Pub. No.: US 2026/0148658 A1
(43) Pub. Date: May 28, 2026

(54) REAL-TIME AND AFTER-ACTION PERFORMANCE TRAINING ANALYTICS

(71) Applicant: Booz Allen Hamilton Inc., McLean, VA (US)

(72) Inventors: Gary Moore, Wichita Falls, TX (US); Justin Lueders, McLean, VA (US); Michael Frame, McLean, VA (US); John Reeme, McLean, VA (US); Kenneth Smith, McLean, VA (US)

(73) Assignee: Booz Allen Hamilton Inc., McLean, VA (US)

(21) Appl. No.: 19/400,715

(22) Filed: Nov. 25, 2025

Related U.S. Application Data
(60) Provisional application No. 63/725,798, filed on Nov. 27, 2024.

(51) Int. Cl. G09B 9/24; G06F 18/15; G06F 18/21; G06F 18/22

(52) U.S. Cl. CPC G09B 9/24; G06F 18/15; G06F 18/217; G06F 18/22

(57) ABSTRACT

Embodiments can relate to techniques for comparing and evaluating data from disparate data sources and/or data streams. The technique can involve receiving data from at least two disparate data sources and/or data streams (the data including object movement information). The technique can involve abstracting data and generating data sets representative of an attribute of an object, generating normalized data sets, aggregating normalized data sets based at least in part on time windows spanning between attributes of abstracted data, which can be stored. The method can involve retrieving data from the aggregated data sets and comparing the retrieved data to benchmark data representative of at least one or more of a standard, a pattern, or a statistic of an attribute of at least one or more objects. An output representative of the comparison can be generated.

### CROSS-REFERENCE TO RELATED APPLICATIONS

This patent application is related to and claims the benefit of priority of U.S. provisional patent application No. 63/725,798, filed on Nov. 27, 2024, the entire contents of which is incorporate herein by reference.

### FIELD

Embodiments can related to systems and methods for tracking an object and displaying data path visualization along with analytics of the object via a user interface.

### BACKGROUND INFORMATION

Training simulation systems exist that track object movement of the user. For instance, it is common for trainee-pilots to use flight simulators to track the aircraft's movement as the trainee-pilot performs training exercise tasks. These systems also provide information to a user (trainee and/or trainer) regarding the performance of the trainee. However, known systems fail to provide a fully integrated framework for analytics to span across training modalities. Furthermore, known systems fail to provide a means to easily convey benchmark analytics to a trainer in a distilled yet comprehensive manner so as to facilitate a trainer being able to quickly identify which trainee they should focus on and/or which tasks a trainee should focus on.

### SUMMARY

An exemplary embodiment can relate to a data comparator and evaluation system. The data comparator and evaluation system can include a data input module configured to receive data from at least two disparate data sources and/or data streams. The received data can include object movement information. The data comparator and evaluation system can include a data analytics module configured to: abstract data and generate data sets representative of an attribute of an object; generate normalized data sets by normalizing data within a data set of the data sets and/or normalizing data across at least two data sets; and aggregate normalized data sets based at least in part on time windows spanning between attributes of abstracted data. The data comparator and evaluation system can include a memory configured to receive and store the aggregated data sets. The data comparator and evaluation system can include an evaluation module configured to: retrieve data from the aggregated data sets and compare the retrieved data to benchmark data representative of at least one or more of a standard, a pattern, or a statistic of an attribute of at least one or more objects; generate an output representative of the comparison. The data comparator and evaluation system can include a presentation module configured to receive the output and display a graphic illustrating at least one or more of: actual movement of an object; deviated movement of actual movement relative to a benchmark movement; matching of actual movement relative to a benchmark movement; and/or a degree with which actual movement deviated from or matched with a benchmark movement.

An exemplary embodiment can relate to a method for comparing and evaluating data from disparate data sources and/or data streams. The method can involve receiving data from at least two disparate data sources and/or data streams, the data including object movement information. The method can involve abstracting data and generating data sets representative of an attribute of an object. The method can involve generating normalized data sets by normalizing data within a data set of the data sets and/or normalizing data across at least two data sets. The method can involve aggregating normalized data sets based at least in part on time windows spanning between attributes of abstracted data. The method can involve storing the aggregated data sets. The method can involve retrieving data from the aggregated data sets and comparing the retrieved data to benchmark data representative of at least one or more of a standard, a pattern, or a statistic of an attribute of at least one or more objects. The method can involve generating an output representative of the comparison. The method can involve displaying a graphic illustrating at least one or more of: actual movement of an object; deviated movement of actual movement relative to a benchmark movement; matching of actual movement relative to a benchmark movement; and/or a degree with which actual movement deviated from or matched with a benchmark movement.

### BRIEF DESCRIPTION OF THE DRAWINGS

Other features and advantages of the present disclosure will become more apparent upon reading the following detailed description in conjunction with the accompanying drawings, wherein like elements are designated by like numerals, and wherein:

FIGS. 1A and 1B show exemplary system block diagrams for an embodiment of the data comparator and evaluation system;

FIG. 2 shows an exemplary flow diagram of analytics performed by an embodiment of the data comparator and evaluation system;

FIG. 3 shows an exemplary system architecture for an embodiment of the data comparator and evaluation system;

FIGS. 4-6 shows exemplary user interface displays for an embodiment of the data comparator and evaluation system;

FIG. 7 shows an exemplary summary report that can be generated by an embodiment of the data comparator and evaluation system;

FIGS. 8-9 show exemplary graphical and textual analytics that can be illustrated via a user interface of an embodiment of the data comparator and evaluation system;

FIG. 10 illustrates an exemplary scoring scheme that can be used by an embodiment of the data comparator and evaluation system;

FIGS. 11-14 show additional embodiments of graphical and textual information conveyed via a user interface of an embodiment of the data comparator and evaluation system;

FIGS. 15-16 show exemplary benchmarking data and scoring techniques that can be used for an embodiment of the data comparator and evaluation system; and

FIGS. 17-20 show exemplary analytic results that can be presented by an embodiment of the data comparator and evaluation system which account for time windows for taking corrective action during a flight simulation scenario.

### DETAILED DESCRIPTION

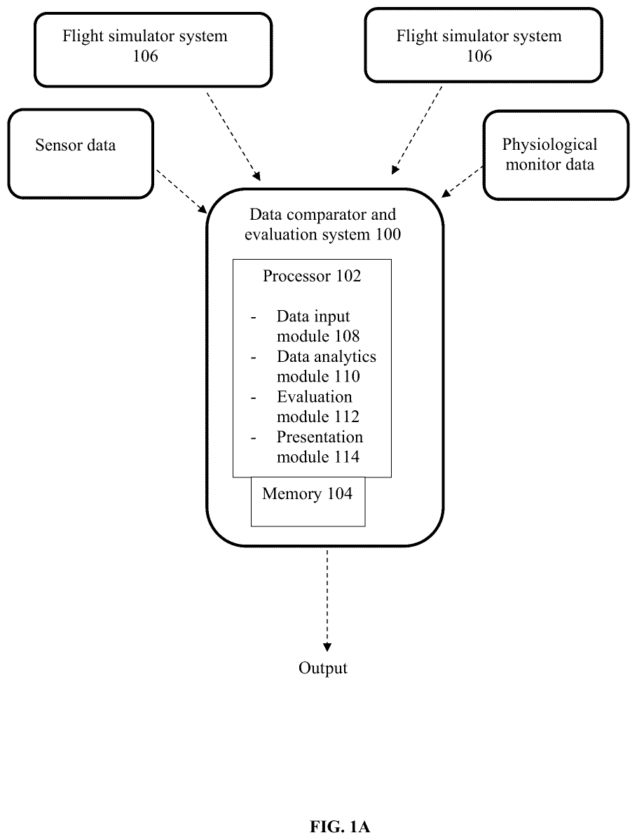

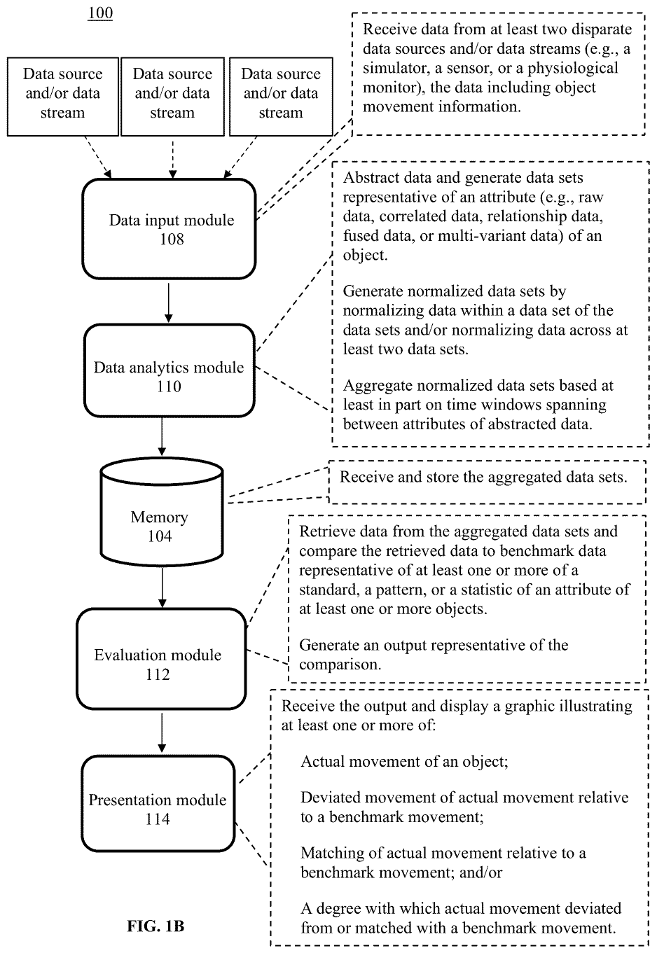

Referring to FIGS. 1A and 1B, embodiments can relate to a data comparator and evaluation system 100. The data comparator and evaluation system 100 can used in conjunction with (be part of, included with, or in communication with) other systems (e.g., simulator system, decision support system, etc.). Exemplary embodiments describe and illustrate the data comparator and evaluation system 100 being used in conjunction with a flight simulator system 106, but it is understood that it can be used in conjunction with other systems that would benefit from data comparison and evaluation.

The data comparator and evaluation system 100 can include one or more processors 102. The data comparator and evaluation system 100 can include one or more memories 104. The processor(s) 102 can be operatively associated with or include the memory(ies) 104. One or more algorithms, models, programming logic, etc. can be stored in the memory 104 as data structure in the form of instructions, and the processor 102 can execute the instructions to implement any of the functions disclosed herein.

The processor can be any of the processors disclosed herein. The processor can be part of or in communication with a machine (logic, one or more components, circuits (e.g., modules), or mechanisms). The processor can be hardware (e.g., processor, integrated circuit, central processing unit, microprocessor, core processor, computer device, etc.), firmware, software, etc. configured to perform operations by execution of instructions embodied in algorithms, data processing program logic, artificial intelligence programming, automated reasoning programming, etc. Use of processors herein can include any one or combination of a Graphics Processing Unit (GPU), a Field Programmable Gate Array (FPGA), a Central Processing Unit (CPU), etc. The processor can include one or more processing modules. A processing module can be a software or firmware operating module configured to implement any of the method steps disclosed herein. The processing module can be embodied as software and stored in memory, the memory being operatively associated with the processor. A processing module can be embodied as a web application, a desktop application, a console application, etc.

The processor can include or be associated with a computer or machine readable medium. The computer or machine readable medium can include memory. The computer or machine readable medium can be configured to store one or more instructions thereon. The instructions can be in the form of algorithms, program logic, a model, etc. that cause the processor to perform any of the functions described herein.

Any of the memories discussed herein can be computer readable memory configured to store data. The memory can include a volatile or non-volatile, transitory or non-transitory memory, and be embodied as an in-memory, an active memory, a cloud memory, etc. Embodiments of the memory can include a processor module and other circuitry to allow for the transfer of data to and from the memory, which can include to and from other components of a communication system. This transfer can be via hardwire or wireless transmission. The communication system can include transceivers, which can be used in combination with switches, receivers, transmitters, routers, gateways, wave-guides, etc. to facilitate communications via a communication approach or protocol for controlled and coordinated signal transmission and processing to any other component or combination of components of the communication system. The transmission can be via a communication link. The communication link can be electronic-based, optical-based, opto-electronic-based, quantum-based, etc.

The processor can be in communication with other processors of other devices (e.g., a computer device, a desktop computer, a laptop computer, a computer system, etc.). These other devices can be part of the flight simulator system 106, for example. Any of those other devices can include any of the exemplary processors disclosed herein. Any of the processors can have transceivers or other communication devices/circuitry to facilitate transmission and reception of wireless signals. Any of the processors can include an Application Programming Interface (API) as a software intermediary that allows two applications to talk to each other. Use of an API can allow software of a processor of the data comparator and evaluation system 100 to communicate with software of another processor of the data comparator and evaluation system 100 or a processor of the other device(s), etc.

Any data transmission between a processor and memory, between a processor and a database, between processors of the system, between a processor and processor(s) of other devices, etc. can be via a pull operation (e.g., the processor can pull the data) or a push operation (e.g., the data can be pushed to the processor). The processor can receive the data in streaming format, or store it in memory before being processed. In addition, embodiments of any of the algorithms, models, etc. disclosed herein can be developed as an application software (an “App”) to be implemented on a processor of a device. The App can be sent via a streaming format, or the App can be sent and stored on a memory associated with or accessed by the device.

As noted herein, the processor can be configured to be a component of, used in combination with, or in communication with another device/system—e.g., this can include the processor being part of the device/system, the device/system being part of the processor, the processor in communication with the device/system, etc. “Being part of” can include being on a same substrate or integrated circuit. For instance, the processor can be a component of, used in combination with, or in communication with a predictive modeling system, a decision support system, an automated control system, etc. The processor can use the model or algorithm or provide the model or algorithm to the device/system to assist with or augment the performance of these devices/systems.

While exemplary embodiments may describe and/or illustrate one processor and one memory, it is understood that the system can include any number of processors and memories.

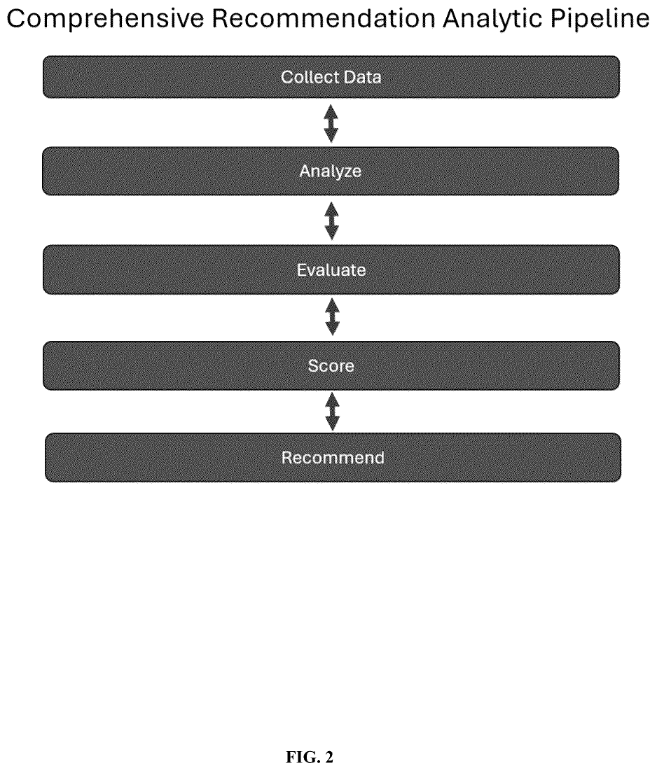

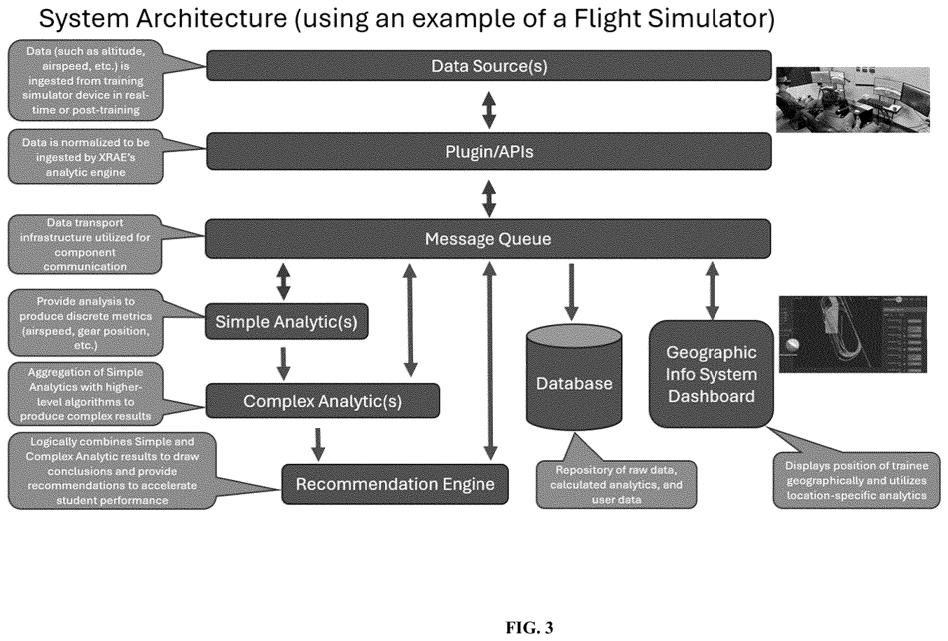

Referring to FIGS. 1-3, the data comparator and evaluation system 100 can include one or more data input modules 108. The data input module 108 can be configured to receive data from data source(s) and/or data stream(s). The data sources can include a flight simulator, a sensor, a physiological monitor, an audio module (e.g., for voice transmission and/or recording), etc. The data stream can include one or more types of data from a data source. For instance, a flight simulator system 106 may generate an altitude data stream, an airspeed data stream, a flap position data stream, a g-force data stream, etc. The data source can also include sensors, such as motions sensor, eye gaze sensors, etc. that generate movement data streams, eye gaze data streams, etc. of trainee pilots. The data source can also include physiological monitors, such heart rate monitors, pupil diameter monitors, body temperature monitors, skin conductance monitors, etc. that generate heart rate data streams, pupil diameter data streams, body temperature data streams, skin conductance data streams, etc. The data source can also include an audio module for receiving and/or transmitting (e.g., in data stream(s)) audio communications (e.g., voice communications, audio data, etc.). Any of these sensors or monitors can be part of the data comparator and evaluation system 100, the flight simulator system 106, be part of another system that is in communication with the data comparator and evaluation system 100 and/or the flight simulator system 106, etc. The sensors can monitor can be positioned within the flight simulator system's 106 cockpit area, on the trainee pilot, on the trainee pilot's flight suit, in the trainee pilot's helmet, etc. The data sources can also include any of the processors and memories disclosed herein so as to facilitate data processing and data transmission to and from the sensors/monitors and the data comparator and evaluation system 100.

As will be explained herein, the data comparator and evaluation system 100 is able to aggregate data from multiple data sources and/or multiple data streams and present the aggregation visually and textually on a display (e.g., via a user interface) in real time or near real time. These data sources and/or data streams can be disparate data sources and disparate data streams. Being disparate can mean that the data generated therefrom can be generated from different platforms, recording in different measurement units, encoded in different formats, etc. One of the technical improvements of the data comparator and evaluation system 100 is to be able to aggregate data from disparate data sources and/or disparate data streams and present the aggregation in real time or near real time. Thus, it is contemplated for the data input module 108 to be configured to receive data form at least two disparate data sources and/or data streams.

The data received from the flight simulator system 106 can include object movement information. For instance, as the trainee is conducting training exercises, the aircraft's (e.g., the object) simulated position and movement (e.g., altitude, speed, acceleration, pitch, roll, yaw, etc.) is recorded by the flight simulator system 106. This simulated position and movement is received by the data input module 108. Again, the data input module 108 can receive one or more data streams related to the object movement information from a flight simulator system 106, can receive object movement information from one or more flight simulator systems 106, can receive one or more data streams from a sensor, can receive sensor data from one or more sensors, can receive one or more data streams from a physiological monitor, can receive physiological monitor data from one or more physiological monitors, etc. The data from a particular flight simulator system 106, a trainee, etc. can be tagged and encoded (e.g., via metadata) to associate that data with that particular flight simulator system 106, trainee, etc.

The data comparator and evaluation system 100 can include one or more data analytics modules 110. The data analytics module 110 can be configured to abstract data and generate data sets representative of one or more attributes of one or more objects. For instance, the data analytics module 110 can generate data sets of one or more objects (e.g., aircrafts) from one or more flight simulator systems 106 based on the data received by the data input module 108. An attribute of an object can be a measurement or a statistic about the object, the object's movement, the trainee associated with the object, the trainer associated with the trainee, the sensor/monitor information pertaining to the trainee, etc. The attribute can be raw data, correlated data (e.g., Pearson correlation), relationship data (e.g., regression analysis), fused data (e.g., data fusion), multivariant data (e.g., multivariant analysis), etc. of the object(s), the object(s) movement, the trainee(s), the trainer(s), etc. The data analytics module 110 can be configured to generate normalized data sets by normalizing data within a data set of the data sets and/or normalizing data across at least two data sets. The data abstraction and normalization can be achieved by using one or more data schemas. For instance, a data schema (e.g., definition of a structure and organization of data) can be generated for each type of data source and/or each type of data stream. The data schemas would be generated and stored in the system 100 before implementation and the data schemas would be generated based on priori knowledge of the data source(s) and/or data stream(s) to be acquired. These data schemas can be used by the data analytics module 110 to extract, transform, load (ETL) data for abstraction. The abstracted data can be normalized using known data normalization techniques to facilitate proper data comparison and other analytics.

The data analytics module 110 can be configured to aggregate normalized data sets. Data aggregation can be performed to group or cluster data based correlations or relationships of data with respect to the object's movements. The correlations/relationships of data can be determined and associated with an object's movement, wherein an aggregated data set can be generated that is representative of this. For instance, an aircraft's banking movement can be associated with other data such as heart rate, g-force, pitch, time-into-turn, etc.

The data aggregation can be based at least in part on time windows spanning between attributes of abstracted/normalized data. For instance, sticking with the banking movement example above, it may be desirable to understand when the banking movement occurred, to which degree the banking occurred, whether the degree of banking was modified, etc. This type of aggregation is not only important for training but is one of the technical improvements of the data comparator and evaluation system 100. For instance, based on standard operating procedures, a trainee should have or should not have banked at the time they did. If they banked when they were supposed to, it may be the case that they should not have banked to the degree they did. If they banked when they were not supposed to bank, it may be the case that they took corrective action by mainlining the bank and taking other action or by changing the bank, etc. This is how the time window spanning between attributes comes into play. As noted above, the banking may not have been a proper movement, but it still might be OK if the trainee pilot took or is taking corrective action after the banking move and did or is doing so within a certain time. The time to take corrective action will depend on the type of movement that was made and other movements (e.g., speed, altitude, pitch, g-force, etc.) that had been made or are being made. The time to take corrective action with also depend on which corrective actions the trainee pilot took or is taking. For instance, the trainee pilot may decide to maintain the bank but take other measures, or the trainee pilot may decide to change the degree of bank, or the trainee pilot may decide to level the aircraft, etc. The properness of each corrective action, the time within which the trainee pilot takes the corrective action, and whether the trainee pilot's corrective action is considered OK, creates a potential hazard, or results in a hazardous move can be determined by an evaluation module 112 (discussed later) analyzing the aggregated data.

The data comparator and evaluation system 100 can include one or more memories 104 configured to receive and store the aggregated data sets. The data comparator and evaluation system 100 can continue to store the aggregated data sets as they are being generated. The aggregated data sets can be stored in data tables.

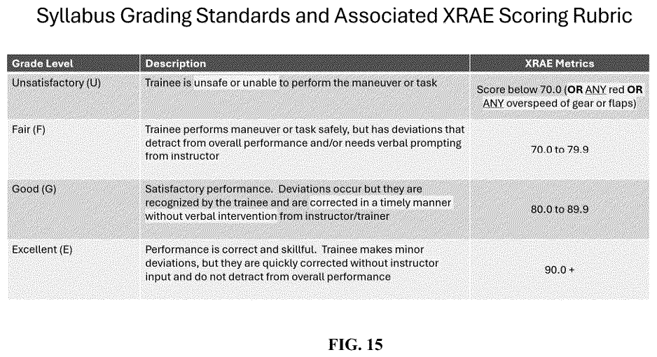

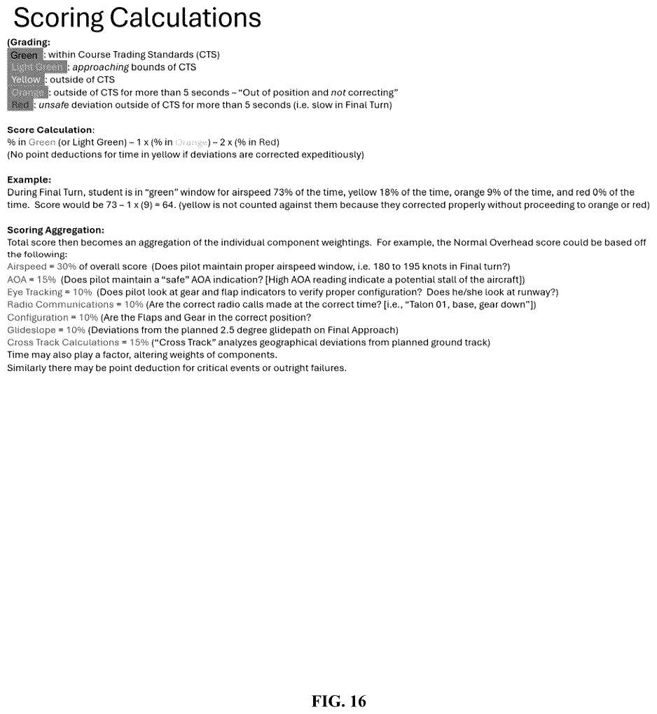

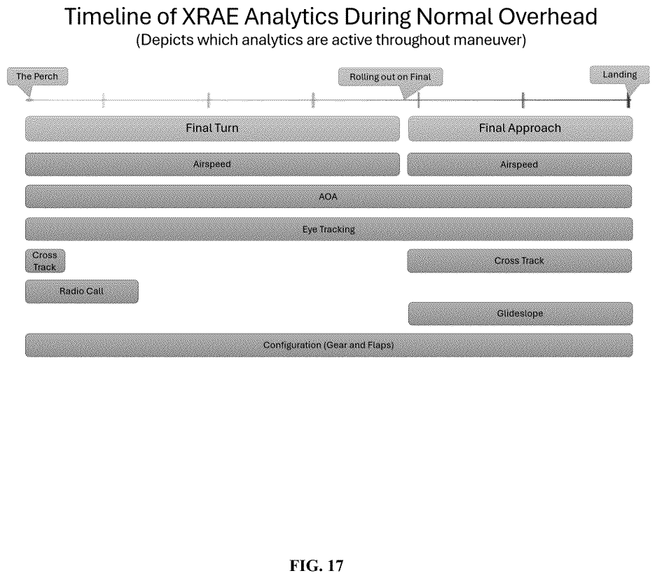

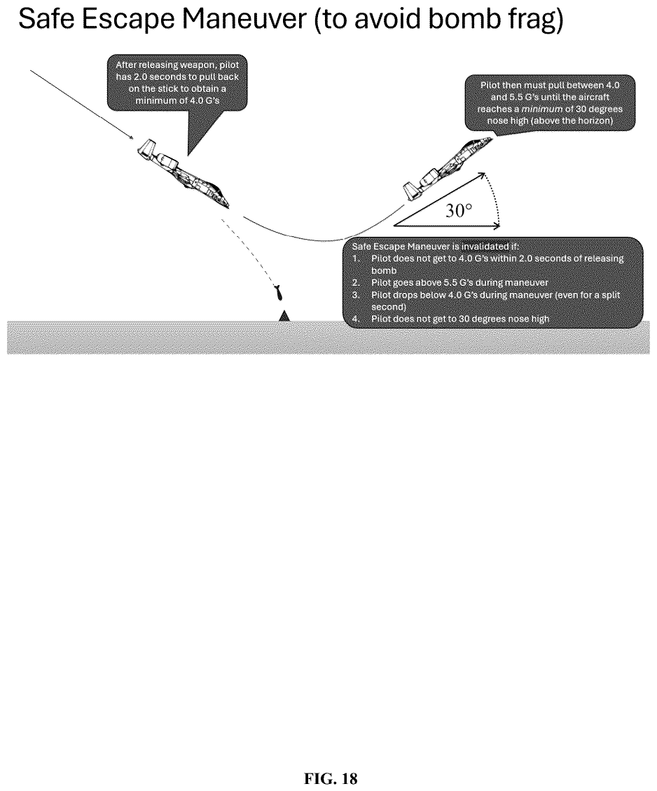

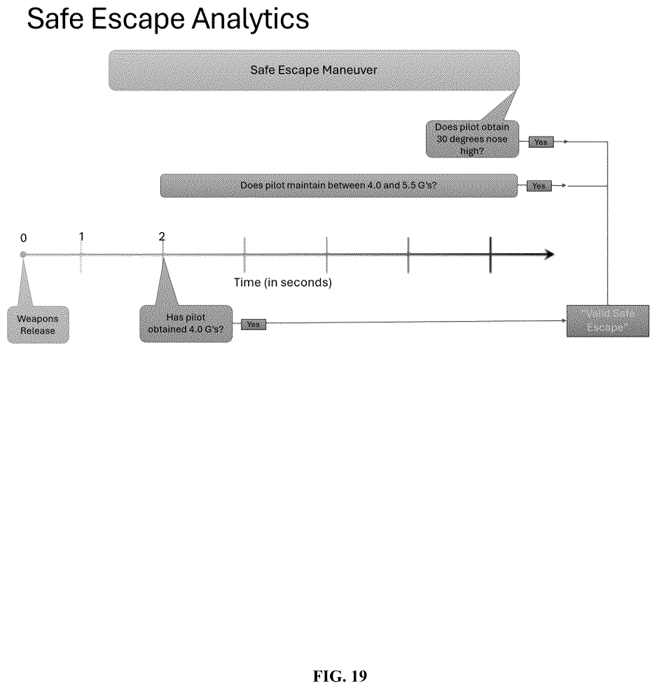

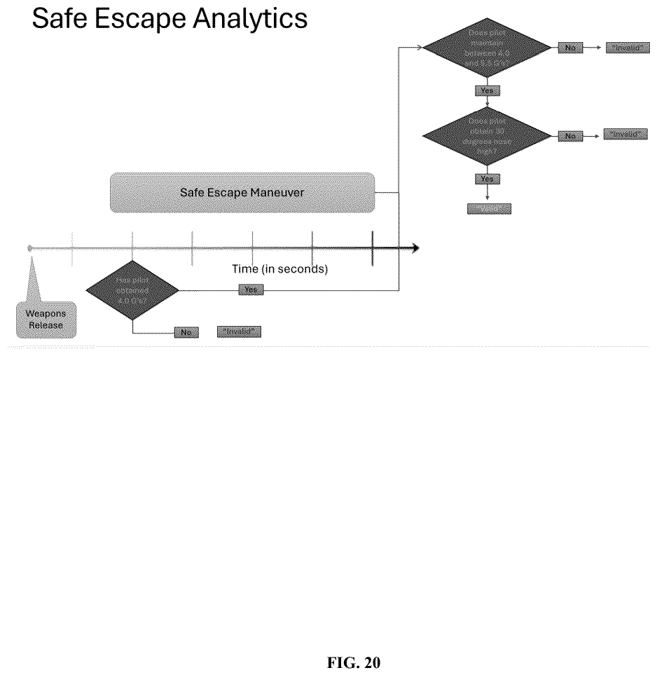

The data comparator and evaluation system 100 can include one or more evaluation modules 112. The evaluation module 112 can be configured to retrieve data from the aggregated data sets (e.g., retrieve data from the data tables) and compare the retrieved data to benchmark data representative of a standard, a pattern, a statistic, etc. of an attribute(s) of an object(s). The evaluation module 112 can include encoded data of standard operating procedure guidelines, of operating specifications of the object (e.g., the aircraft), etc. (See FIGS. 15-26). The evaluation module 112 can also have access to historical data of an object, a trainee associated with the object, etc. This data can be used to generate benchmark data. The benchmark data can be a standard the trainee is expected to follow, an improvement in flight maneuver based on a pattern of similar maneuvers the trainee performed in the past, adherence to a flight maneuver based on statistic associated with a type of aircraft, other trainees, etc.

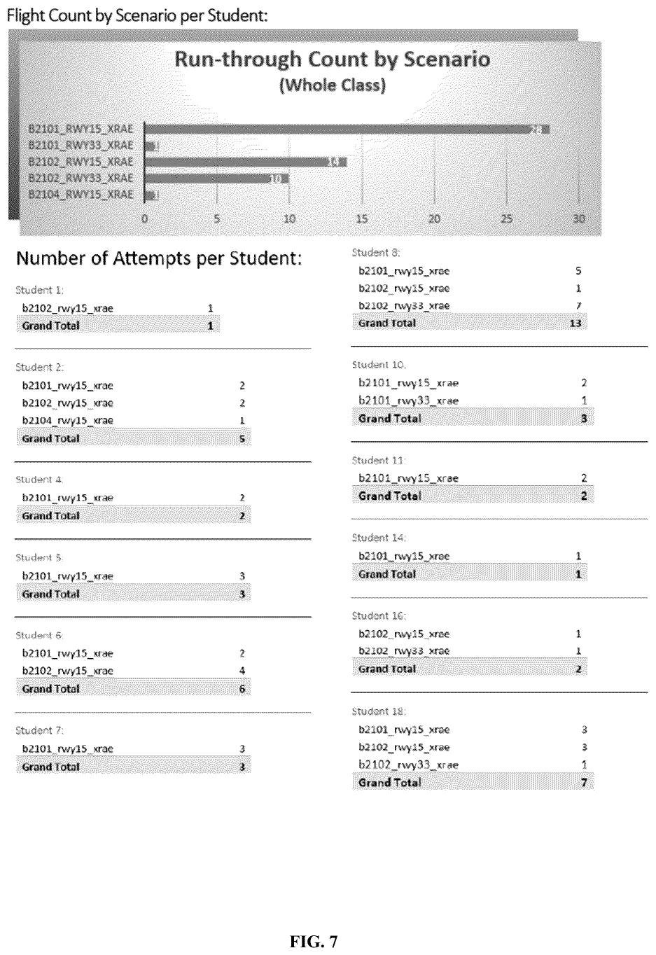

With reference to FIGS. 7 and 17-20, as noted above, the aggregated data sets can include time window data. The evaluation module 112 can use the time window data to determine the properness of a corrective action, the time within which the trainee pilot takes the corrective action, and whether the trainee pilot's corrective action is considered OK, creates a potential hazard, or results in a hazardous move. One example of how this can be done is for the evaluation module 112 to assign weights to object movement data—e.g., assign a weight to altitude, assign a weight to pitch, etc. so that these become weighted parameters. The evaluation module 112 can then evaluate whether the actions taken by the trainee pilot fall within the category of OK, potential hazard, or hazardous move. Trainee pilots are subjected to simulated environments and there may be more than one movement to take to address the conditions in the simulated environment. Even if the standard operating procedure does not dictate a banking movement under the conditions, it still may be OK and even deemed proper, provided the trainee pilot took proper measures and did so within a suitable time window so as to not generate a potential hazard or a hazardous move. Moreover, a deviation from a standard operating procedure, while not preferred, may still be OK if the trainee pilot took the proper measures and within a suitable time window. This is where the weighted parameters come into play. The evaluation module 112 can assign weights to the parameters based on the conditions being simulated and the movement(s) performed and evaluates them against standard operating procedure guidelines, operating specifications of the object (e.g., the aircraft), etc. The weighted parameters can be used in an objective or cost function, for example, to evaluate against standard operating procedure guidelines, operating specifications of the object (e.g., the aircraft), etc. to facilitate generating an output representative of the comparison.

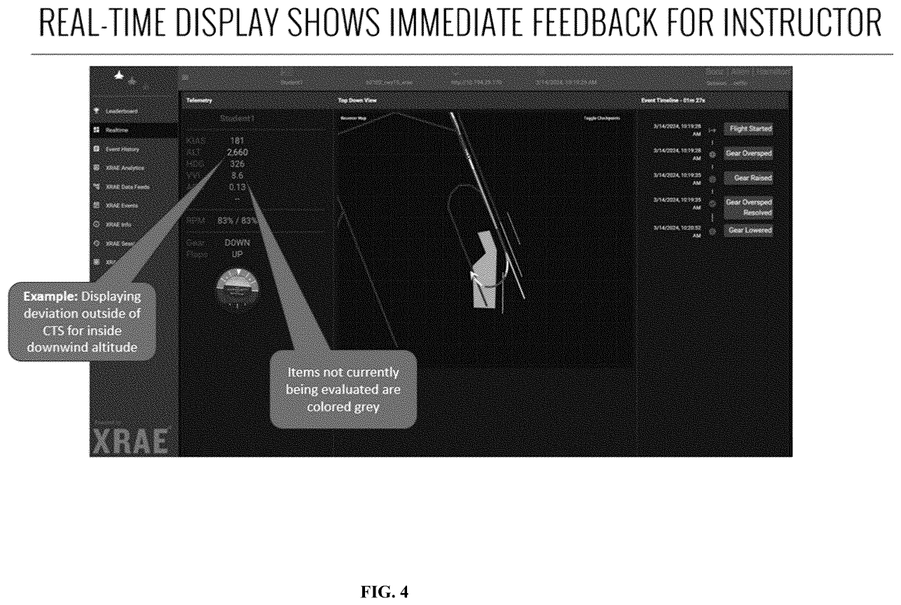

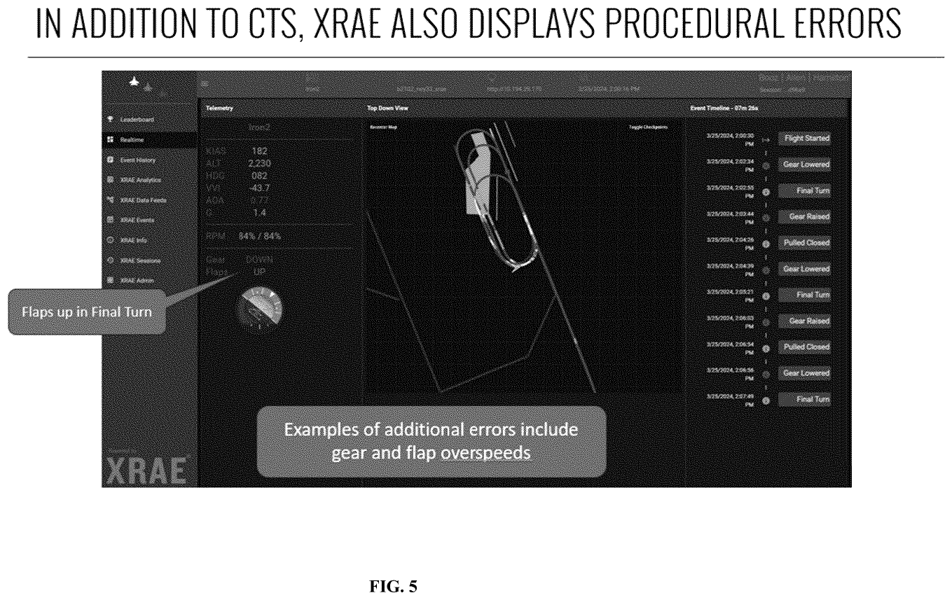

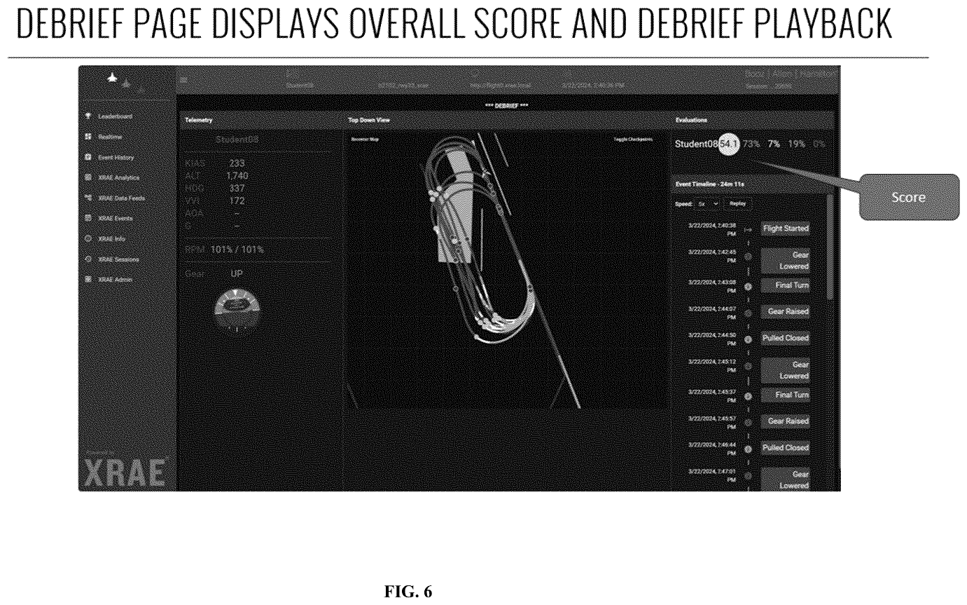

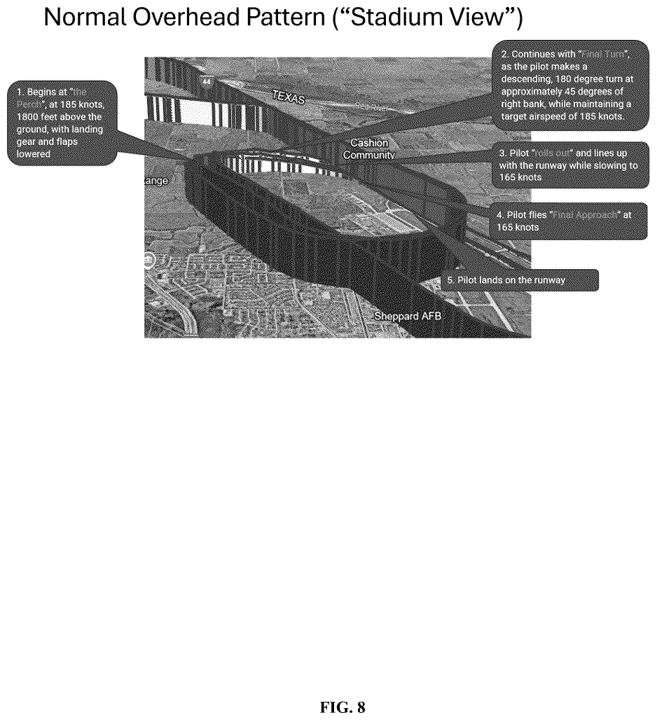

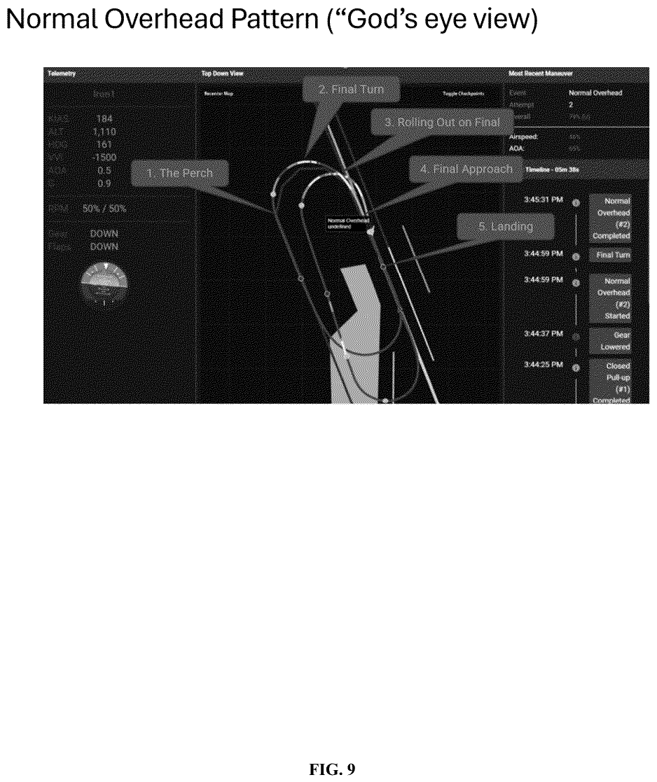

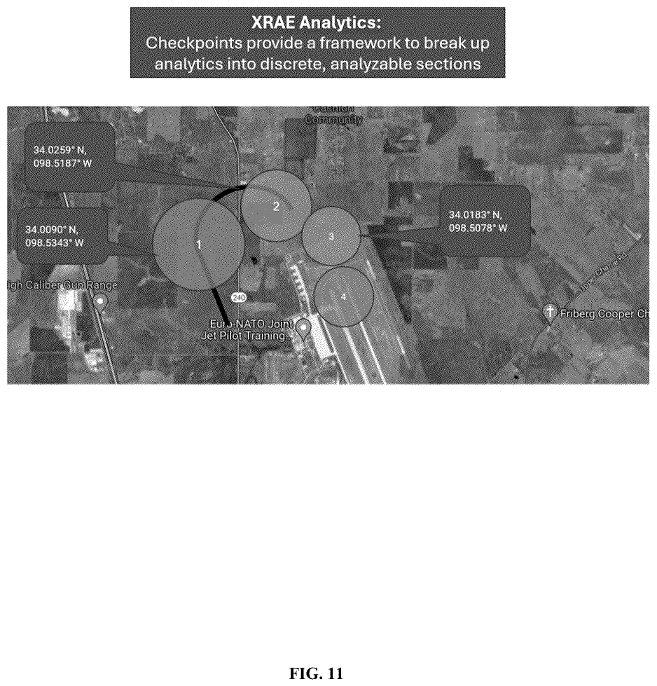

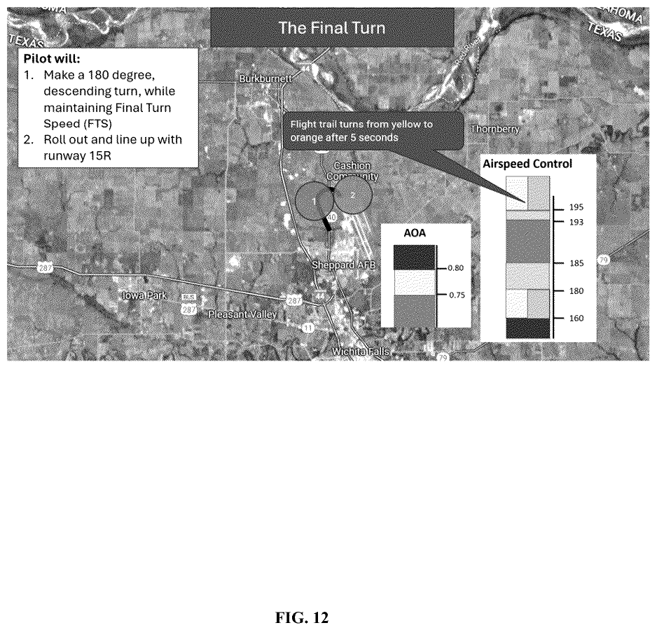

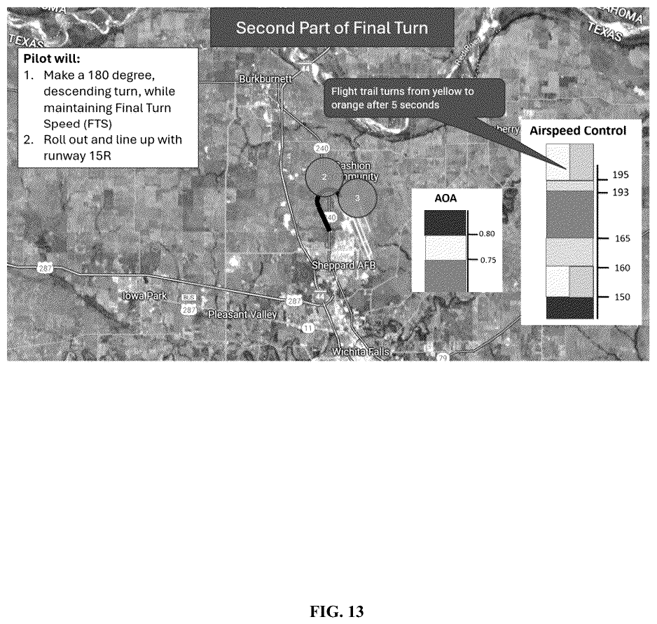

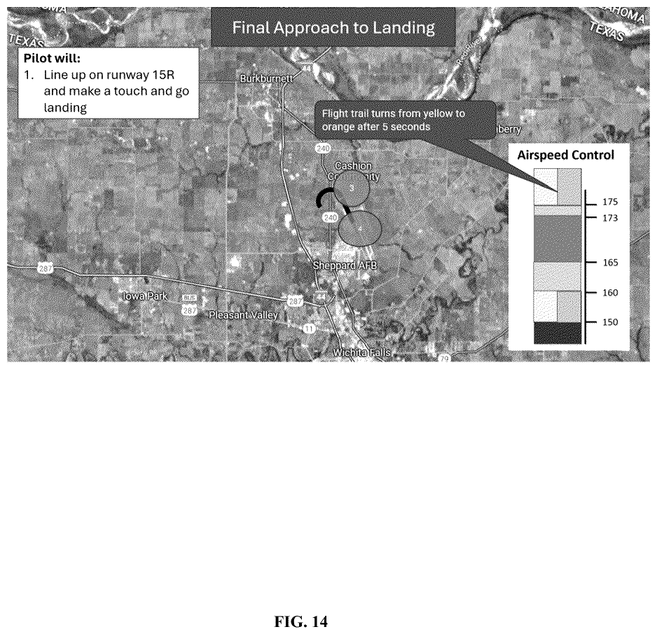

The data comparator and evaluation system 100 can include one or more presentation modules 114 configured to receive the output and display a graphic illustrating the output(s) from the evaluation module 112. For instance, the data comparator and evaluation system 100 can include a display (e.g., computer monitor) and the presentation module 114 can be configured to generate a user interface via the display. (See FIGS. 4-6, 8-9, 11-14, and 17-20). It is contemplated for the presentation module 114 to display: 1) actual movement of an object; 2) deviated movement of actual movement relative to a benchmark movement; 3) matching of actual movement relative to a benchmark movement; and/or 4) a degree(s) with which actual movement deviated from or matched with a benchmark movement. For instance, the presentation module 114 can generate a graphic via the user interface that shows color coded path(s) of the object's movement. The actual movement of the object can be in a first color, the deviated movement of actual movement relative to a benchmark movement can be in a second color, the matching of actual movement relative to a benchmark movement can be in a third color, etc. In addition, or in the alternative, the user interface can generate color coded graphics of the degree(s) with which actual movement deviated from or matched with a benchmark movement. This can also take into account the time window and whether an OK, a potential hazard movement, or hazardous movement occurred. For instance, the user interface can show the path the aircraft took and color the portion(s) of the path as green for OK movement(s), color the portion(s) of the path as yellow for potential hazardous movement(s), color code the portion(s) of the path as red for hazardous movement(s). The user interface can also display graphics or textual data pertaining to any deviations and corrective actions the trainee pilot made or did not make that resulted in an OK movement, a potential hazardous movement, or a hazardous movement. Within this display, a trainer can quickly observe and assess which trainee requires additional attention and which areas to focus on. In addition, the trainer is able to observe multiple trainees simultaneously without a degradation in supervising or monitoring by the trainer.

In some embodiments, the evaluation module 112 can be configured to use one or more artificial intelligence techniques to perform its comparison. This can include a deep learning model, a neural network model, a random forest model, a decision tree model, etc. This can allow the evaluation module 112 to perform predictive analytics, generate recommendations, generate alerts even prior to the trainee making a mistake, etc. The artificial intelligence model can also be used to assess under which conditions the trainee pilot becomes stressed, distracted, etc. These determinations can be provided to the presentation module 114 and presented as part of the output. It is also contemplated for the artificial intelligence model to be used to determine which trainer or trainer tactics appear to be more or less effective for a particular trainee, a particular type of simulated event, etc.

With an artificial intelligence model being implemented on the evaluation module 112, the presentation module 114 can be configured to display a graphic illustrating: 1) actual movement of an object; 2) deviated movement of the actual movement relative to a benchmark movement; 3) a determination for deviated movement or matched movement; 4) a correlation or relationship between deviated movement and a benchmark movement; 5) a correlation or relationship between matched movement and a benchmark movement; and/or 6) a recommendation to prevent or reduce deviated movement.

As noted herein, the data comparator and evaluation system 100 can receive data from more than one data source (e.g., more than one flight simulator system 106). This can allow the data comparator and evaluation system 100 to evaluate two or more trainee pilots working independently but in concert within a simulated environment. For instance, the data sources can include a first simulator 106 generating object movement information for a first object and a second simulator 106 generating object movement information for a second object. The evaluation module 112 can evaluate the object movement(s) independently and in accordance with benchmark movements for the two trainee pilots working in concert to reach an objective within the simulated environment. With this evaluation, the presentation module 114 can be configured to display a graphic illustrating: 1) actual movements of the first object and the second object; and 2) deviated movement of the actual movements relative to benchmark movements. The benchmark movements can include a standard, a pattern, or a statistic of concerted movements of the first object and the second object.

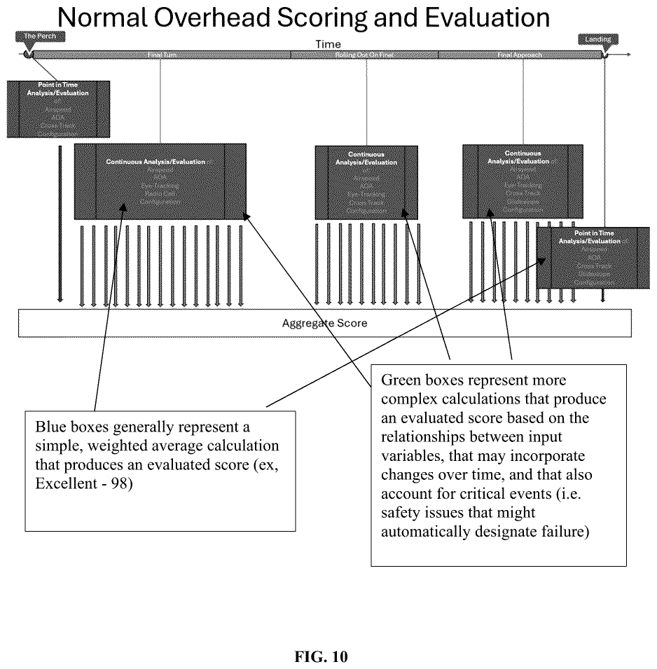

Referring to FIG. 10, in some embodiments, the evaluation module 112 can generate a score of the comparison. The score can be an assessment of how well the trainee pilot performed against benchmark movement(s). The score can take into account: 1) actual movement of the object; 2) deviated movement of actual movement relative to a benchmark movement; 3) matching of actual movement relative to a benchmark movement; and 4) a degree with which actual movement deviated from or matched with a benchmark movement.

In any example described herein, artificial intelligence and/or machine learning (AI/ML) models may be employed to analyze input data and generate predictions, classifications, data insights, or recommendations. Furthermore, one or more management components may interface with AI/ML components to enable automated execution of tasks and actions to achieve practical applications described herein. As an example, a result generated by AI/ML modeling may be leveraged to trigger execution of automated decisions, raise inflection points, notifications, and modify process flow, among other non-limiting examples. Additionally, exemplary AI/ML modeling may further be integrated into a software data platform to enable data ingestion and connection to data endpoints and services which may feed critical and novel data (and metadata), including exemplary signal data, to AI/ML modeling for continuous processing. This can include continuous provision of feedback for enhanced training and adaption of AI/ML modeling as well as various types of signal data described herein that can provide customized and novel real-time (near real-time) contextual analysis of integrated applications/services.

The AI/ML models described herein may include, without limitation, supervised learning models, unsupervised learning models, reinforcement learning models, deep learning neural networks, transformer-based architectures, ensemble models, or hybrid combinations thereof. Input data may comprise but is not limited structured, semi-structured, and/or unstructured data, and further comprise any type of record or documentation including but not limited to: numerical records, categorical data, textual data, audio, video, sensor data, network activity, web pages, documents, messages e.g., text or chat), social media, historical project outcomes, knowledge graphs, and ontology. Preprocessing operations may include feature extraction, dimensionality reduction, normalization, tokenization, vectorization, embedding generation, and/or transformation into numerical representations suitable for model consumption. Non-limiting examples of types of data layers may comprise but are not limited to: raw data layers, pre-processing or clean-up layers, feature engineering or transformation layers, embedding layers (e.g., word embedding, node embeddings, latent learned features), model input layers, hidden or intermediate layers (e.g., neural network specific such as convolution layers, recurrent/temporal layers, transformer/self-attention layers), output or scoring layers (e.g., softmax, regression, ranking), post-processing layers (e.g., re-rank, weighting, filtering), and feedback or reinforcement layers (training and re-ranking based on collected signal data). Data layers may further incorporate metadata, contextual attributes, and/or weighting factors customized/defined by users including those derived from organizational data (e.g., guidelines, performance history, or user preferences).

Non-limiting examples of supervised learning that may be applied comprise but are not limited to: nearest neighbor processing; naive bayes classification processing; decision trees; random forests; gradient boosting; linear regression; support vector machines (SVM) neural networks (e.g., convolutional neural network (CNN) or recurrent neural network (RNN)); and transformers, among other examples. Non-limiting of unsupervised learning that may be applied comprise but are not limited to: application of clustering processing including k-means for clustering problems, hierarchical clustering, mixture modeling, other dimensionality reduction, etc.; application of association rule learning; application of latent variable modeling; anomaly detection; and neural network processing, among other examples. Non-limiting of semi-supervised learning that may be applied comprise but are not limited to: assumption determination processing; generative modeling; low-density separation processing and graph-based method processing, among other examples. Non-limiting of reinforcement learning that may be applied comprise but are not limited to: value-based processing; policy-based processing (policy gradient methods); and model-based processing, Q-learning, among other examples. Non-limiting examples of transformer models comprise but are not limited to: encoder-decoder architectures, attention-based mechanisms, and large language models (e.g., contextual embeddings, sequence-to-sequence learning), among other examples. Non-limiting examples of ensemble models comprise but are not limited to: combinations of classifiers or regressors (e.g., boosting, bagging, stacking), voting/aggregation (e.g., majority or weighted voting), Bayesian averaging, ensemble neural networks, snapshot ensembles, or dropout ensembles, among other examples.

Multiple AI/ML layers may be combined, wherein a rules-based layer enforces hard constraints, while a machine learning layer optimizes within permissible solution spaces. Transformer-based embeddings may be combined with clustering methods to identify latent structures in key data sets (e.g., workforce or project data). Graph-based models may represent relationships between entities (e.g., employees, skills, roles, teams), while reinforcement learning layers optimize data points (e.g., assignments, roles, responsibilities) over repeated simulations.

In any AI/ML example, models are continuously trained and optimized to adapt and improve performance and accuracy. Training may comprise but is not limited to: forward propagation, backpropagation, gradient descent, stochastic gradient optimization, hyperparameter tuning, and/or automated model selection, or a combination thereof. Training datasets, validation datasets, and test datasets may be partitioned according to standard practices or dynamically adjusted based on input constraints. Loss functions may further be applied to minimize loss and improve accuracy. Loss functions may comprise but are not limited cross-entropy, mean squared error, hinge loss, cosine similarity, or domain-specific cost functions, among other examples. Weights, biases, and other parameters may be updated iteratively to minimize loss functions while maximizing predictive performance.

Additionally, AI/ML processing may comprise scoring, ranking, and weighting to optimize output. Model outputs may include raw prediction scores, probability distributions, confidence intervals, or ranked recommendation lists, among other non-limiting examples. Scoring functions may incorporate weighting factors set by administrative user, defined in documentation (e.g., internal guidelines, user-defined constraints, business rules, or supervisory input), knowledge graphs, or a combination thereof, among other examples. Ranking mechanisms may generate ordered lists of candidate outputs (e.g., role assignments, matches, or classifications), optimized according to multiple objective functions (accuracy, diversity, compliance). In some examples, ensemble scoring may be used, wherein multiple models contribute weighted outputs to produce a final ranking or classification.

Furthermore, AI/ML modeling is further adapted to enhance intelligible understanding and guide usage of output. Model interpretability may be enhanced using feature attribution methods (e.g., LIME), attention visualizations, or surrogate models, among other examples. Outputs may be accompanied by context, descriptions, explanations, etc. that indicate the most significant contributing factors or features, provide comparative analysis, suggestions, recommendations, etc. Human-in-the-loop feedback may be incorporated, enabling iterative retraining and calibration of model behavior. Fairness and bias-mitigation techniques may be employed, including re-weighting, counterfactual fairness testing, or adversarial debiasing.

Moreover, models may be deployed as APIs, microservices, or embedded modules within larger enterprise systems including via widgets, iFrames, etc. Real-time inference engines may support streaming data, while batch inference may be used for periodic or large-scale analysis. Models may be updated dynamically, retrained periodically, or adapted through web-based learning modules (e.g., cloud computing). Furthermore, AI/ML models described herein may be implemented using cloud-based platforms, distributed computing systems, edge devices, or hybrid architectures. Storage may be supported by relational databases, graph databases, data warehouses, or vector databases optimized for embeddings. Moreover, training and modeling may comprise a hybrid approach leveraging additional technologies and capabilities including but not limited to: plural AI/ML models, Parallelization, GPU acceleration, specialized hardware (e.g., TPUs), quantum computing, hybrid quantum/AI-ML solutions may be utilized for efficient training, inference, and acceleration of AI/ML modeling for complex problem solutions. For instance, hybrid AI/ML and quantum computing technology may be integrated and used to solve complex matters such as simulations, encryption, large-scale optimization, among other examples.

The present disclosure is further adapted to enable trained AI/ML modeling to integrate with data endpoints of applications or services (including third-party integrations) processing to collect real-time (or near real-time) signal data for improved processing efficiency, enhanced accuracy, improved training, and the adaptation of AI/ML modeling for practical applications, among other technical advantages. For instance, application of trained AI processing (e.g., one or more trained machine learning models) may be adapted to evaluate data endpoints pertaining to users within an organization (e.g., individuals, teams or project groups), signal data from data endpoints from third-party data integrations, user actions including past and/or current user actions, user preferences or settings, application/service log data, etc., This additional signal data analysis may help yield determinations as to enhancing decision points and outputs, determining how (and/or when) to automate decision processing, raise notifications including recommendations/suggestions, and generation and management of data insights, among other examples. Non-limiting examples of signal data that may be collected and analyzed comprises but is not limited to: device-specific signal data collected from operation of one or more user computing devices; user-specific signal data collected from specific tenants/user-accounts with respect to access to any of: devices, login to a distributed software platform, applications/services, etc.; application-specific data collected from usage of applications/services and associated endpoints; profile data, internal documentation (e.g., policies, guidelines, organizational values), third-party integrations (e.g., client apps, social media, etc.) or a combination thereof. Analysis of such types of signal data in an aggregate manner may be useful in helping generate contextually relevant determinations, data insights, etc. Analysis of exemplary signal data may comprise identifying correlations and relationships between the different types of signal data, where telemetric analysis may be applied to generate determinations with respect to a contextual state of user activity with respect to different host application/services and associated endpoints. Analyzing of signal data, including user-specific signal data, occurs in compliance with user privacy regulations and policies. For instance, users may consent (or opt-in) to monitoring of signal data to improve user experience and operation of applications/services associated with a software data platform.

Additionally, the present disclosure may further comprise one or more application/service components configured to manage host applications/services and associated endpoints. The application/service component may be further configured to present, through interfacing with other computer components described herein, an adapted graphical user interface (GUI) that provides user notifications, GUI menus, GUI elements, etc., to manage front-end representation of the present disclosure including the ability to execute processing operations and methods (e.g., computer-implemented methods) described herein. An application/service component may further be configured to manage different versions or representations of the present disclosure that are packaged for user access. For example, a stand-alone version of a role-based mapping management app/service may be providable for access by users. In one instance, this may be a SaaS implementation where organizational users may access services described herein via a tenant (e.g., dedicated or shared). In other examples, the present disclosure may be integrable as a component to interface within an organizational software data platform, for instance, that can further tie into additional organizational data endpoints, among other examples

In any case, an application/service component further manages respective endpoints associated with individual host applications/services, which have been referenced in the foregoing description. In some examples, an exemplary host application/service may be a component of a distributed software platform (e.g., cloud computing platform) providing a suite of host applications/services and associated endpoints, services, microservices, etc. A distributed software platform is configured to providing access to a plurality of applications/services, thereby enabling cross-application/service usage to enhance functionality of a specific application/service at run-time. For instance, a distributed software platform enables interfacing between a host service related to management of a distributed collaborative canvas and/or individual components associated therewith and other host application/service endpoints (e.g., configured for execution of specific tasks). Distributed software platforms may further manage tenant configurations/user accounts to manage access to features, applications/services, etc. as well access to distributed data storage (including user-specific distributed data storage), and distributed knowledge repositories. Moreover, specific host application/services (including those of a distributed software platform) may be configured to interface with other non-proprietary application/services (e.g., third-party applications/services) to extend functionality including data transformation and associated implementation. Role-based access control (RBAC) may be implemented to manage permissions and privileges for access to data described herein.

An exemplary application/service component is further configured to present, through interfacing with computer processing devices, an adapted GUI that provides user notifications, GUI menus, GUI features, etc. The GUI may comprise interactive components such as GUI elements, dashboards, visualization panels, report generation and management, input fields for receiving user selections and parameters, and feedback, among other examples. The system may further generate and present real-time notifications, alerts, or recommendations to the GUI, including contextualized data insights derived from analytics engines or AI/ML models. Such insights may be rendered as charts, tables, or ranked lists, and may dynamically update in response to new data inputs, user actions, or system-detected events, for example, based on processing of exemplary signal data described herein. A GUI processing layer may further be implemented to support adaptive layouts, prioritization of displayed information based on relevance scores, and customizable notification preferences to enhance usability and decision-making. In further examples, a GUI is generated and adapted to manage AI/ML modeling including administrative features/functionalities and controls as described in the foregoing, all of which may further created customized, adapted, AI/ML modeling.

The present disclosure describes a unique combination of data repositories as inputs, which in itself can be utilized to generate, train, and adapt AI/ML modeling for specific and practical purposes beyond what standard AI solutions provide. Above that, examples of the present disclosure may further transform data inputs to improve the training and usability of AI/ML modeling including for comparative analysis. For instance, exemplary inputs described herein may be utilized to train and adapt AI/ML modeling to improve, accuracy, processing efficiency (underlying devices, modeling, and processing methods), and overall contextual correlation and usability, including for comparative data analytics and performance indicators. Input data that may be utilized to train and adapt AI/ML modeling comprises but is not limited to: flight simulations from one or more operators (e.g., individual flight simulations and/or group/formation flight simulations) including those conducted in real-time (near real-time) or historical (e.g., previously recorded simulations) of any of the foregoing; flight manuals, training guides, technical data; mission-specific and/or aircraft-specific specifications (including aircraft use, wear, aging) parameter or contextual data; environmental and terrain data; pilot/operator data including psychological data, cognitive data, body/function data (i.e., heartrate, eye gaze, breathing, reaction times); audio or acoustic data (including aircraft cabins, noise properties); sensor data (e.g., aircraft sensors, human worn sensors) including force data, haptic data, vibrational data, rotational data, geometric data); electrical systems data; and military intelligence data, among other examples. In further examples, any of the foregoing data points, individually or in aggregation, can be utilized to build new data objects for AI/ML model training and usage. That is, individual input data can be transformed into newer, deeper correlated, data objects, which can further be utilized to adapt AI/ML modeling to generate richer and more contextual analytics, KPIs, etc., for improved training and analysis (e.g., flight simulator training evaluations of pilots, planes, groups, environments, etc.). It is also to be understood that exemplary GUIs can be adapted to generate, and present novel data analytics, KPIs, insights, etc. related to this deeper level of contextual training and understanding.

Consider an example where a specific pilot has conducted multiple flight simulations for a specific mission having mission-specific parameters, using the same aircraft, and same terrestrial/environmental conditions. AI/ML modeling may be trained to generate data objects and/or data labeling representative of a general pilot profile for that pilot including for data points such as those relating to the behaviors, actions, voice, eye, gaze, breathing, cognition, defensive tactics, offensive tactics, hit/miss ratios, etc. Additionally, AI/ML modeling be further be trained to generate data objects and/or data labeling representative of the mission-specific operations of that pilot during specific flight simulations including for data points specific to parameters, contextual attributes, etc. of the mission including but not limited to: behaviors, actions, voice, eye gaze, breathing, cognition, defensive tactics, offensive tactics, hit/miss ratios, and further do so with mission-specific data point correlation including time stamp data, reactions to environmental/terrain conditions or changes thereto, hits/misses of enemy aircrafts including relative to specific maneuvers, counter measures, etc.) In this way, there are infinite possibilities of unique, contextual deep analytics that can be generated for a pilot, including for specific flight missions, which can be used to improve AI/ML model operation (including scoring, ranking) but also be leveraged to generate novel, deeper, and more accurate data insights, data analytics, KPIs, alerts, notifications, suggestions/recommendations, etc., which may be generated in real-time (or near real-time) during an operation of a flight simulation or afterwards as contextual reports/reporting. Novel feature vectors (or sets of feature vectors) may be generated related to specific pilots, groups of pilots, aircrafts, missions, environments/terrains, etc., including those that adapt dynamically based on performance/operation/reaction as a flight simulation progresses. This can greatly improve processing accuracy, results, and reduce error rates, while also improving contextuality, understanding, and correlation when dealing with high levels of complexity in aggregating a plurality of different data inputs and factors present in flight simulation evaluation, which may not typically be easily associated.

In further instances, novel aggregated data analytics, metrics, or KPIs may be created that are configured to be presented in association with operation of an exemplary flight simulation or reporting associated therewith. For instance, a novel aggregated metric may be generated that correlates a pilot's breathing patterns, with its heart rate, and reaction time. Or a data analytic that correlates a pilot's cognitive recognition to specific environmental terrain aspects or offensive/defensive measures (e.g., emergence or action taken by enemy aircrafts. It is to be understood that any of the exemplary parameters or attributes described herein can be leveraged to generate new and novel aggregated and deeper contextual analytics or KPIs including for comparative analysis whether compared to a baseline indication or another pilot.

Through continuous application of AI/ML modeling, exemplary analytics may be dynamically updated through operation of flight simulation. In further instances, dynamic update and correlation of exemplary data analytics and KPIs, may further yield generation of snapshot representation of flight simulations, including inflection points and, timeline indications of performance, activity, and contextual analysis for comparative analysis. As described herein, visual indications of performance (e.g., color coded indications, badges/icons) may be generated and surfaced to reflect a state of the simulation (including pilot performance). Exemplary visual indications can be generated for the entirety of the flight simulations or portions thereof. For instance, a pilot may have remained on schedule with mission-specific parameters for the first portion of the simulation but fall behind course on a later portion of the simulation. Visual indicators can be generated to reflect performance in such individual segments of the mission simulation, as well for the overall performance of pilot for the mission-specific parameters. In further instances, such visual indications may also be correlated into reports/reporting for pilots and simulations including aggregated reporting for one or more pilots or simulations. For instance, comparative analysis may be performed of pilots and/or simulations, where visual indications may be generated for improving observation and understanding. In further examples, visual indications from reporting may further be utilized as new data inputs into AI/ML modeling, that is trained to generate data correlations therefrom. From these new data points, novel contextual data insights may be observable and configured for output.

In further examples, AI/ML modeling may be uniquely constructed to generate and manage a data layer that can be made accessible to leverage new, transformed data objects, labels, and aggregated correlations, for many practical applications. For instance, AI/ML modeling may be utilized to generate data insights and/or data analytics that can be surfaced during operation of a flight simulation or afterwards as a reporting. In other examples, real-time (or near real-time) alerts, notifications, suggestions/recommendations, etc., can be surfaced during a flight simulation to aid a pilot or an administrator communicating with a pilot. In this way, the present disclosure provides an extensible and scalable solution applicable to a wide variety of practical applications. In one example, the present disclosure may include generating and maintaining a data insights (or data analytics) data layer that can be integrated into a data platform to interface with other components, data layers, and other integrations (including third-party integrations such as CRMs), whereby the data layer acts as a building block to build a layered system architecture that provides not only a queryable data repository but also a valuable data endpoint for other services to integrate with. Some key non-limiting innovative aspects by which such contextual data insights are used in the present disclosure include but are not limited to: providing exemplary data analytics and KPIs associated with operation of virtual training exercises (e.g., flight simulations); model prediction and training; ability to customize modeling and model scoring including adjustable parameters, weightings, etc., searchable/queryable data repositories (including with a GUI front-end) for contextual data generated and managed by exemplary AI/ML modeling; reporting management including the ability to build out timelines for decision-making or inflexion points during a flight simulation; ability to receive and incorporate feedback to improve, train, adapt AI/ML modeling; and generation of new data objects or customized tags for data (and metadata) that can be usable for improvement of AI/ML modeling, reporting, organizationally, etc. Data insights may be generated and presented through a front-end applications/service associated with an exemplary flight simulator. In additional examples, data insights may further be transmittable to mobile devices associated with an organization as notifications, where users may have configuration control over how and when notifications are surfaced. For instance, an admin operator monitoring/evaluating a flight simulation may wish to receive real-time notification updates or progress sent to a remote computing device.

In further practical applications, an exemplary data layer may be integrated with additional apps/services enable post processing optimization of training exercises where generated recordings of flight simulation(s) or reports generated from flight simulation(s) may be leveraged to create new data objects, reports, etc. In one instance, a pilot or admin (e.g., commanding officer or other pilots) may wish to offer feedback (e.g., in the form of text, audio/recording, video) that can be appended to prior created data points, reports, etc. In that example, a narration or annotation may be made providing commentary on a specific point of the flight simulation. This type of feedback is also utilized to train and adapt AI/ML modeling over time.

As can be appreciated from the present disclosure, embodiments can relate to a method for comparing and evaluating data from disparate data sources and/or data streams. The method can involve receiving data from at least two disparate data sources and/or data streams, the data including object movement information. The method can involve abstracting data and generating data sets representative of an attribute of an object. The method can involve generating normalized data sets by normalizing data within a data set of the data sets and/or normalizing data across at least two data sets. The method can involve aggregating normalized data sets based at least in part on time windows spanning between attributes of abstracted data. The method can involve storing the aggregated data sets. The method can involve retrieving data from the aggregated data sets and comparing the retrieved data to benchmark data representative of at least one or more of a standard, a pattern, or a statistic of an attribute of at least one or more objects. The method can involve generating an output representative of the comparison. The method can involve displaying a graphic illustrating actual movement of an object, deviated movement of actual movement relative to a benchmark movement, matching of actual movement relative to a benchmark movement, a degree with which actual movement deviated from or matched with a benchmark movement, etc.

The method can involve generating a color coded representation of: 1) the actual movement of an object; 2) the deviated movement of actual movement relative to a benchmark movement; 3) the matching of actual movement relative to a benchmark movement; and/or 4) the degree with which actual movement deviated from or matched with a benchmark movement.

In some embodiment, the method can involve displaying a graphic illustrating: 1) actual movement of an object; 2) deviated movement of the actual movement relative to a benchmark movement; 4) a determination for deviated movement or matched movement; 5) a correlation or relationship between deviated movement and a benchmark movement; 6) a correlation or relationship between matched movement and a benchmark movement; and/or 7) a recommendation to prevent or reduce deviated movement.

In some embodiments, the method can involve displaying a graphic illustrating: 1) actual movements of a first object and a second object; and 2) deviated movement of the actual movements relative to benchmark movements. The benchmark movements can include a standard, a pattern, or a statistic of concerted movements of the first object and the second object.

In some embodiments, the method can involve generating an output representative of the comparison that includes a score. The score can take into account: 1) actual movement of an object; 2) deviated movement of actual movement relative to a benchmark movement; 3) matching of actual movement relative to a benchmark movement; and 4) a degree with which actual movement deviated from or matched with a benchmark movement.

It will be understood that modifications to the embodiments disclosed herein can be made to meet a particular set of design criteria. For instance, any of the components, features, or steps of the system, apparatus, or method can be any suitable number or type of each to meet a particular objective. Therefore, while certain exemplary embodiments of the systems and methods disclosed herein have been discussed and illustrated, it is to be distinctly understood that the invention is not limited thereto but can be otherwise variously embodied and practiced within the scope of the following claims.

It will be appreciated that some components, features, and/or configurations can be described in connection with only one particular embodiment, but these same components, features, and/or configurations can be applied or used with many other embodiments and should be considered applicable to the other embodiments, unless stated otherwise or unless such a component, feature, and/or configuration is technically impossible to use with the other embodiments. Thus, the components, features, and/or configurations of the various embodiments can be combined in any manner and such combinations are expressly contemplated and disclosed by this statement.

It will be appreciated by those skilled in the art that the present invention can be embodied in other specific forms without departing from the spirit or essential characteristics thereof. The presently disclosed embodiments are therefore considered in all respects to be illustrative and not restrictive. The scope of the invention is indicated by the appended claims rather than the foregoing description and all changes that come within the meaning, range, and equivalence thereof are intended to be embraced therein. Additionally, the disclosure of a range of values is a disclosure of every numerical value within that range, including the end points.

What is claimed is:

1. A data comparator and evaluation system, comprising:
a data input module configured to receive data from at least two disparate data sources and/or data streams, the received data including object movement information;
a data analytics module configured to:
abstract data and generate data sets representative of an attribute of an object;
generate normalized data sets by normalizing data within a data set of the data sets and/or normalizing data across at least two data sets; and
aggregate normalized data sets based at least in part on time windows spanning between attributes of abstracted data;
a memory configured to receive and store the aggregated data sets;
an evaluation module configured to:
retrieve data from the aggregated data sets and compare the retrieved data to benchmark data representative of at least one or more of a standard, a pattern, or a statistic of an attribute of at least one or more objects;
generate an output representative of the comparison;
a presentation module configured to receive the output and display a graphic illustrating at least one or more of:
actual movement of an object;
deviated movement of actual movement relative to a benchmark movement;
matching of actual movement relative to a benchmark movement; and/or
a degree with which actual movement deviated from or matched with a benchmark movement.

2. The data comparator and evaluation system of claim 1, wherein the presentation module is configured to generate a color coded representation of at least one or more of:
the actual movement of an object;
the deviated movement of actual movement relative to a benchmark movement;
the matching of actual movement relative to a benchmark movement; and/or
the degree with which actual movement deviated from or matched with a benchmark movement.

3. The data comparator and evaluation system of claim 1, wherein:
the at least two disparate data sources include at least one or more of a simulator, a sensor, or a physiological monitor; and
the at least two disparate data streams include two types of data from a simulator, two types of data from a sensor, or two types of data from a physiological monitor.

4. The data comparator and evaluation system of claim 1, wherein:
an attribute of an object includes at least one or more of raw data, correlated data, relationship data, fused data, or multi-variant data.

5. The data comparator and evaluation system of claim 1, wherein:
the evaluation module is configured to use at least one or more of a deep learning model, a neural network model, a random forest model, or a decision tree model for the comparison.

6. The data comparator and evaluation system of claim 1, wherein:
the presentation module is configured to display a graphic illustrating at least one or more of:
actual movement of an object;
deviated movement of the actual movement relative to a benchmark movement;
a determination for deviated movement or matched movement;
a correlation or relationship between deviated movement and a benchmark movement;
a correlation or relationship between matched movement and a benchmark movement; and/or
a recommendation to prevent or reduce deviated movement.

7. The data comparator and evaluation system of claim 1, wherein:
the at least two disparate data sources include a first simulator generating object movement information for a first object and a second simulator generating object movement information for a second object;
the presentation module is configured to display a graphic illustrating:
actual movements of the first object and the second object;
deviated movement of the actual movements relative to benchmark movements; and
wherein benchmark movements include a standard, a pattern, or a statistic of concerted movements of the first object and the second object.

8. The data comparator and evaluation system of claim 1, wherein:
the output representative of the comparison includes a score representative of:
actual movement of an object;
deviated movement of actual movement relative to a benchmark movement;
matching of actual movement relative to a benchmark movement; and/or
a degree with which actual movement deviated from or matched with a benchmark movement.

9. A method for comparing and evaluating data from disparate data sources and/or data streams, the method comprising:
receiving data from at least two disparate data sources and/or data streams, the data including object movement information;
abstracting data and generating data sets representative of an attribute of an object;
generating normalized data sets by normalizing data within a data set of the data sets and/or normalizing data across at least two data sets;
aggregating normalized data sets based at least in part on time windows spanning between attributes of abstracted data;
storing the aggregated data sets;
retrieving data from the aggregated data sets and comparing the retrieved data to benchmark data representative of at least one or more of a standard, a pattern, or a statistic of an attribute of at least one or more objects;
generating an output representative of the comparison;
displaying a graphic illustrating at least one or more of:
actual movement of an object;
deviated movement of actual movement relative to a benchmark movement;
matching of actual movement relative to a benchmark movement; and/or
a degree with which actual movement deviated from or matched with a benchmark movement.

10. The method of claim 9, comprising generating a color coded representation of at least one or more of:
the actual movement of an object;
the deviated movement of actual movement relative to a benchmark movement;
the matching of actual movement relative to a benchmark movement; and/or
the degree with which actual movement deviated from or matched with a benchmark movement.

11. The method of claim 9, wherein:
the at least two disparate data sources include at least one or more of a simulator, a sensor, or a physiological monitor; and
the at least two disparate data streams include two types of data from a simulator, two types of data from a sensor, or two types of data from a physiological monitor.

12. The method of claim 9, wherein:
an attribute of an object includes at least one or more of raw data, correlated data, relationship data, fused data, or multi-variant data.

13. The method of claim 9, wherein:
the comparison is performed using at least one or more of a deep learning model, a neural network model, a random forest model, or a decision tree model.

14. The method of claim 9, wherein the method comprises:
displaying a graphic illustrating at least one or more of:
actual movement of an object; and
deviated movement of the actual movement relative to a benchmark movement;
a determination for deviated movement or matched movement;
a correlation or relationship between deviated movement and a benchmark movement;
a correlation or relationship between matched movement and a benchmark movement; and/or
a recommendation to prevent or reduce deviated movement.

15. The method of claim 9, wherein the at least two disparate data sources include a first simulator generating object movement information for a first object and a second simulator generating object movement information for a second object, and the method comprises:
displaying a graphic illustrating:
actual movements of the first object and the second object; and
deviated movement of the actual movements relative to benchmark movements; and
wherein benchmark movements include a standard, a pattern, or a statistic of concerted movements of the first object and the second object.

16. The method of claim 9, wherein:
the output representative of the comparison includes a score representative of:
actual movement of an object;
deviated movement of actual movement relative to a benchmark movement;
matching of actual movement relative to a benchmark movement; and
a degree with which actual movement deviated from or matched with a benchmark movement.
